(19) United States
(12) Patent Application Publication
(10) Pub. No.: US 2020/0202685 A1
(43) Pub. Date: Jun. 25, 2020

(54) ACTIVE SHOOTER EMERGENCY RESPONSE SYSTEM WITH INTELLIGENT FIREARM VAULTS

(71) Applicant: Platformatics Inc., Bloomington, IN (US)

(72) Inventors: Andrew Feller Gjertsen, Winnetka, IL (US); Matthew Augustine Laherty, Bloomington, IN (US); Michael Jay Siefer, Bremen, IN (US)

(21) Appl. No.: 16/721,264

(22) Filed: Dec. 19, 2019

Related U.S. Application Data
(60) Provisional application No. 62/783,988, filed on Dec. 21, 2018.

(51) Int. Cl. G08B 7/06; G08B 13/16; G08B 21/04; G08B 25/10; H04W 4/90; G08B 25/01

(52) U.S. Cl. CPC G08B 7/06; G08B 13/1672; G08B 21/0438; F21Y 2115/10; H04W 4/90; G08B 25/016; G08B 25/10

(57) ABSTRACT

An active shooter emergency response system includes a plurality of first lighting elements within a building that emit a first color of light in response to detection of a gunshot. The system also includes a plurality of second lighting elements within the building and spaced from the plurality of first lighting elements that emit a second color of light in response to the detection of the gunshot.

### CROSS-REFERENCE TO RELATED APPLICATIONS

This application claims priority to U.S. Provisional Application No. 62/783,988, filed Dec. 21, 2018, the entire contents of which are incorporated herein by reference.

### FIELD OF THE INVENTION

The present invention relates to the field of emergency response systems, particularly those for responding to the presence of an active shooter or shooters within a building.

### SUMMARY

In accordance with some embodiments, an active shooter emergency response system (e.g., with intelligent firearm vaults) is provided. When an active shooter event commences, the location of the shooting and frequency/number of shots fired is analyzed. Correspondingly, RGBW color lights create zones indicating danger/safety and gun vaults with a plurality of locks and role-based authentication provide authorized users with emergency response items like firearms, identification vests and trauma kits.

This system may be deployed in virtually any public or private facility such as offices, schools, retail, or even residential. The underlying infrastructure may require power and communications between the detection systems, lighting systems, intelligent vaults, and notification systems. These various systems may be based on a mixture of technologies including but not limited to AC line power, low voltage power, Power-over-Ethernet, and wired or wireless communications.

In accordance with one embodiment, an active shooter emergency response system includes a plurality of first lighting elements within a building that emit a first color of light in response to detection of a gunshot. The system also includes a plurality of second lighting elements within the building and spaced from the plurality of first lighting elements that emit a second color of light in response to the detection of the gunshot.

In accordance with another embodiment, an active shooter emergency response system includes a detection system that detects a gunshot in a building, a lighting system having a plurality of lighting elements that emit different colors depending upon a proximity to the detected gunshot, and a plurality of intelligent vaults that provide access to weapons and vests for those responding to the detected gunshot.

Other aspects of the invention will become apparent by consideration of the detailed description and accompanying drawings.

### BRIEF DESCRIPTION OF THE DRAWINGS

FIG. 1 is a schematic view of an active shooter response system within a building according to one embodiment, illustrating an active shooter, and color-coordinated zones surrounding the active shooter.

FIG. 2 is a schematic view of the active shooter response system of FIG. 1, illustrating movement of the active shooter and corresponding changes in the color-coordinated zones.

FIG. 3 is a schematic, front view of the building, again illustrating various color-coordinated zones of the active shooter response system of FIG. 1.

FIGS. 4 and 5 are schematic views of the active shooter response system of FIG. 1, illustrating locations of gun vaults.

FIG. 6 is a schematic view of the active shooter response system of FIG. 1 illustrating color-coordinated zones for use in directing medical assistance after an active shooter event.

FIG. 7 is a schematic, front view of the building, again illustrating the various color-coordinated zones for use in directing medical assistance after an active shooter event.

FIG. 8 is a schematic view of one of the gun vaults, used for handguns.

FIG. 9 is a schematic view of another of the gun vaults, used for long rifles.

FIGS. 10 and 11 are flowcharts illustrating how the active shooter response system may operate depending upon the number of gunshots detected.

Before any embodiments of the invention are explained in detail, it is to be understood that the invention is not limited in its application to the details of embodiment and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited.

### DETAILED DESCRIPTION

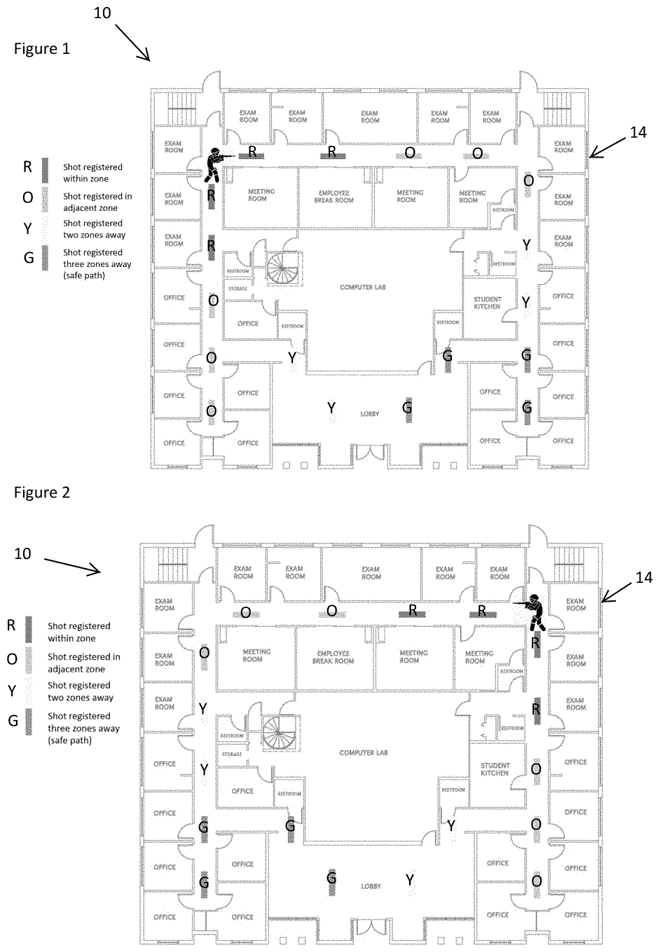

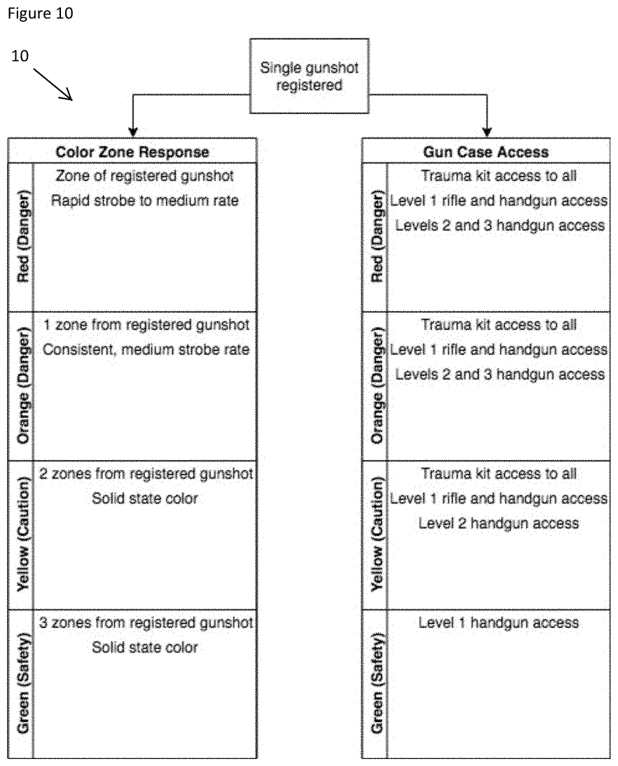

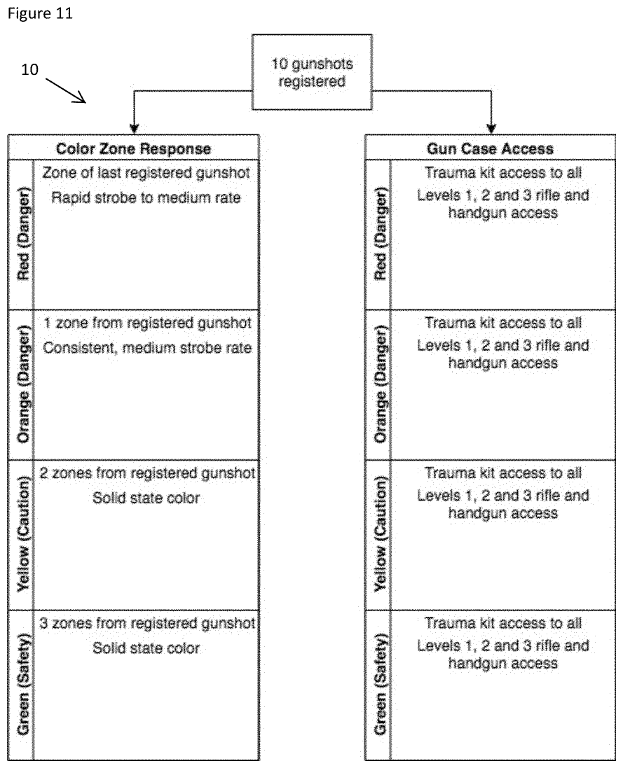

FIGS. 1-11 illustrate an exemplary embodiment of an active shooter response system 10. The active shooter response system 10 may be used for example in buildings (e.g., office buildings, schools, retail buildings, residential buildings, etc.) to detect and respond to active shooter events.

### RGBW Color Light Zones

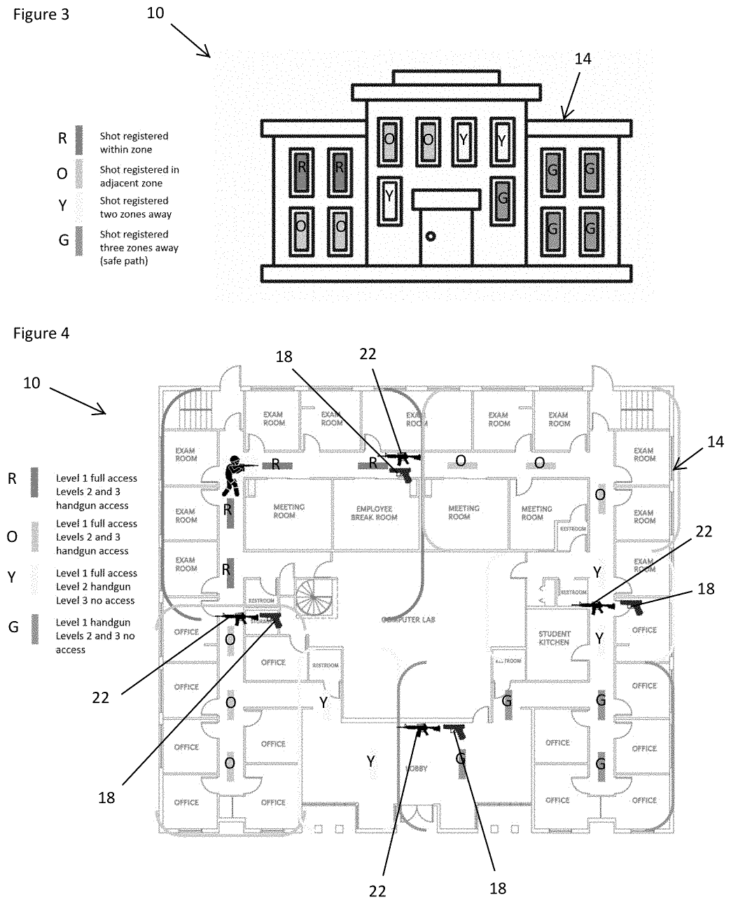

In some embodiments, when an active shooter opens fire in a building 14, a gunshot detection sensor (not illustrated) registers heat, pressure waves, and/or muzzle flash. After the first gunshot is detected, an emergency response protocol commences. Zones are areas where devices within their boundaries are given commands in response to defined events. They are user-configurable and established based on floorplan mapping. In some embodiments, the immediate area around the gunshot sensor becomes a ‘hot zone’ where RGBW color lights in the area immediately turn red (e.g., see zone and lighting elements labeled “R” in FIGS. 1-3) while simultaneously entering into a fast strobe state to indicate imminent danger. Over the course of a minute, the strobe rate decreases in speed. Color lights in adjacent zones either laterally or above/below on different floors enter into an orange colored (e.g., see zone and lighting elements labeled “O” in FIGS. 1-3), slower strobe-rate state to indicate the proximity of danger. Color lights in zones that are two zones removed from the registered gunshot enter into a yellow colored (e.g., see zone and lighting elements labeled “Y” in FIGS. 1-3) solid state to indicate nearby danger. Color lights in zones that are three zones removed from the registered gunshot enter into a green colored (e.g., see zone and lighting elements labeled “G” in FIGS. 1-3) solid state to indicate a path to safety (FIGS. 1 and 3).

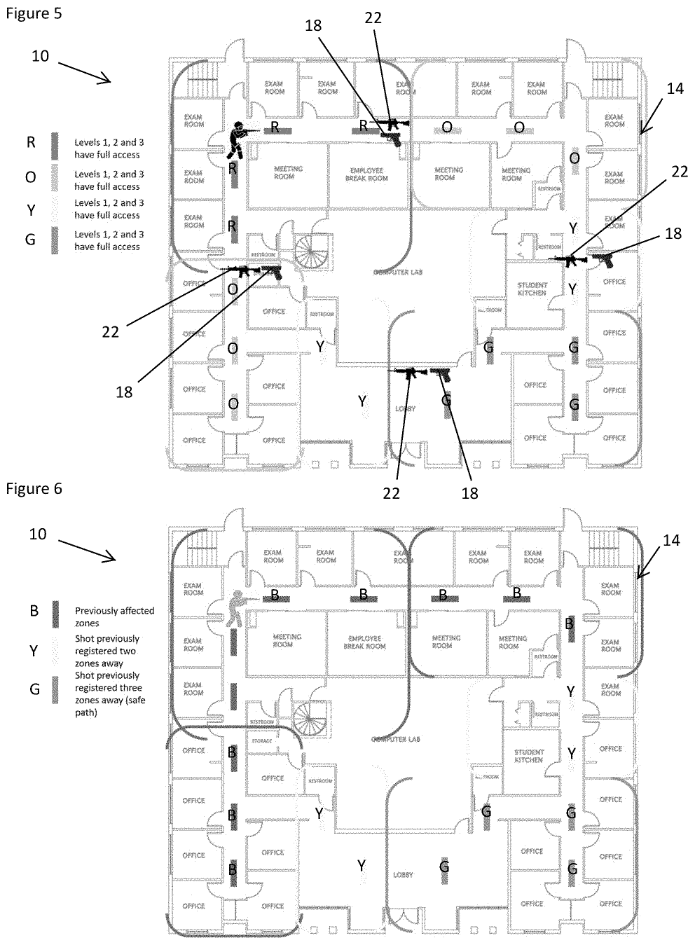

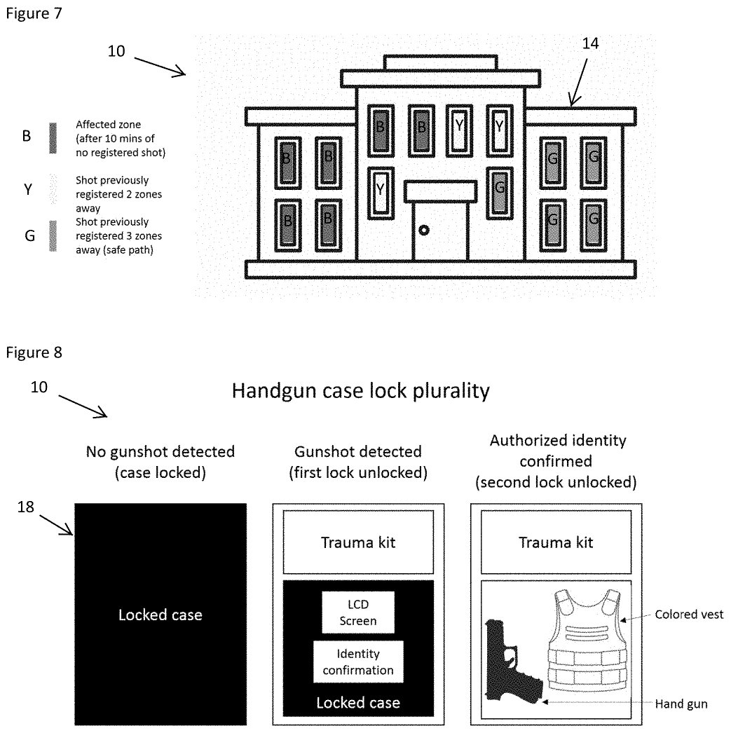

Every additional gunshot detected resets the colored lights in the corresponding zones to account for movement/location of the active shooter and recency of the last shot fired (FIGS. 1 and 2). Ten minutes (or any other predetermined time period) after the last gunshot has been detected, any zone that was once colored red or orange during the active shooter event will turn blue (e.g., see zone and lighting elements labeled “B” in FIGS. 6 and 7). This is used to identify areas where victims may be and point medical help in the right direction (see for example FIG. 5 during the event, and FIGS. 6 and 7, 10 minutes after the last registered shot).

In some embodiments, any new gunshots that are registered after this time interval resets the protocol to the appropriate red and orange zones to indicate imminent danger at the proper locations in the building 14. If the active shooter has not moved to a new zone, yellow and green color zones are not affected by the time interval, as they remain in their solid colored state to indicate areas of caution and the path to safety, respectively. The color lights can, however, be reset to a green state by emergency responders to denote that a zone has been fully cleared and is now safe to occupy. All other non-color lights in red and orange zones may immediately turn off when a gunshot is registered. This is in an attempt to limit the sight of the active shooter or perpetrator(s).

### Intelligent Gun Vaults

In some embodiments, the system 10 features two different types of smart-unlocking gun vaults with a plurality of locks: a handgun vault 18 (see for example FIGS. 4, 5, and 8) and a long-rifle vault 22 (see for example FIGS. 4, 5, and 9). These are installed to provide trained and authorized building occupants with a defense against the perpetrator(s) while waiting for emergency responders or other backup to arrive. Using either RFID readers, identification cards, fingerprint readers, iris readers, biometric readers or other identity verification systems grants the authorized user access to the firearm.

Role-based access to the firearms may be implemented in a variety of levels. The levels grant different authorized users different access to firearms, taking into account the particular zone in which the gun vault is located relative to the active shooter's location. These levels can be configured as the end user wishes. In some embodiments, a single registered gunshot grants level 1 responders access to handguns anywhere on site, or a long rifle in red, orange, and yellow zones. Level 2 responders have access to handguns in all red, orange, or yellow zones. Level 3 responders only have access to handguns in red or orange zones. All gun cases within a red, orange, or yellow zone unlock their first lock (e.g., to a first compartment) to allow anyone access to trauma kits after a gunshot is registered (FIG. 4) without access to the firearms which remain locked in the vault.

If more than a predetermined number of shots are registered, for example 10, the shooting is considered a mass casualty event that requires heightened defense. Subsequently, both handgun and long rifles are available to authorized building occupants anywhere on-site, in addition to the trauma kits (FIG. 5). After verifying their identity, the trained and authorized building occupants unlock the final lock and gain access to both the firearm and a colored vest kept concealed within the case called the ‘color of the day’. The color is not known to all building occupants, but uniform throughout the site so that responding building occupants can wear it during an event and distinguish themselves from the active shooter or perpetrator. This vest is kept behind the second lock of the gun case so that when an authorized individual gains access to the firearm, they can put on the vest.

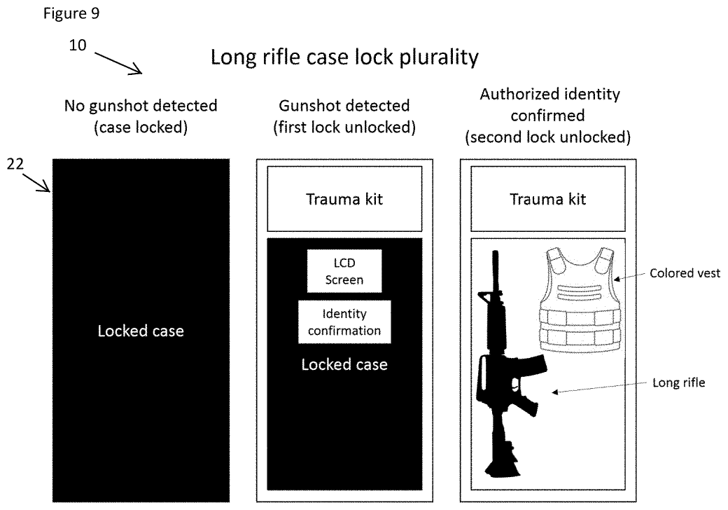

In some embodiments, an LCD screen on the outside of the gun case provides the location of the last registered shot so that authorized building occupants taking the firearms know where to go. This same location information could also be pushed to mobile devices of authorized building occupants and first responders. The separate locked compartments of the handgun and long rifle cases, along with the contents of the cases, are schematically illustrated by FIGS. 8 and 9.

All protocols for emergency response like role-based access, RGBW color zone coverage, timing of color changes, and total gunshots needed to unlock each lock of the gun vaults can all be determined by the end user. This easily configurable solution allows for complete customization to fit the needs of different end users.

### Notification System

In some embodiments, every time a gunshot is detected, a push notification is sent to everyone who is subscribed to the message distribution system, including local emergency response groups. The notification includes the exact location of the last registered gunshot to aid in both locating the shooter and identifying areas for building occupants to avoid. The messages also include the ‘color of the day’ which reveals the secret color of the vests found within the gun cases.

Vocalization of the push notifications can also be played over the PA system in response to the various tiers of active shooter events. These messages can aid in guiding those without access to their mobile devices either to the shooter to stop them, or away from the shooter to avoid them.

Although the invention has been described in detail with reference to certain preferred embodiments, variations and modifications exist within the scope and spirit of one or more independent aspects of the invention as described.

1. An active shooter emergency response system comprising:
a plurality of first lighting elements within a building configured to emit a first color of light in response to detection of a gunshot;
a plurality of second lighting elements within the building and spaced from the plurality of first lighting elements and configured to emit a second color of light in response to the detection of the gunshot.

2. The active shooter emergency response system of claim 1, further comprising a plurality of third lighting elements within the building and spaced from both the plurality of first lighting elements and the plurality of second lighting elements, wherein the plurality of third lighting elements are configured to emit a third color of light in response to the detection of the gunshot.

3. The active shooter emergency response system of claim 2, further comprising a plurality of fourth lighting elements within the building and spaced from the plurality of first lighting elements, the plurality of second lighting elements, and the plurality of third lighting elements, wherein the plurality of fourth lighting elements are configured to emit a fourth color of light in response to the detection of the gunshot.

4. The active shooter emergency response system of claim 3, wherein the first color of light is red, the second color of light is orange, the third color of light is yellow, and the fourth color of light is green.

5. The active shooter emergency response system of claim 1, wherein the plurality of first lighting elements are configured to define a first zone of the building within which an active shooter is located.

6. The active shooter emergency response system of claim 5, wherein the plurality of first lighting elements are configured to enter into a fast strobe state to indicate imminent danger based on presence of the active shooter.

7. The active shooter emergency response system of claim 1, wherein the plurality of first lighting elements are configured to turn to a different color after a predetermined prior of time has passed since the detection of the gunshot.

8. The active shooter emergency response system of claim 1, further comprising a gun vault in the building having a first lock and a second lock, wherein the first lock is configured to be unlocked upon the detection of the gunshot.

9. The active shooter emergency response system of claim 8, wherein the gun vault includes an LCD screen and an identity verification system that are accessible after the first lock is unlocked.

10. The active shooter emergency response system of claim 9, wherein the second lock is configured to be unlocked via the identify verification system.

11. The active shooter emergency response system of claim 8, wherein the gun vault includes a trauma kit, a control vest, and a hand gun that are accessible after the second lock has been unlocked.

12. The active shooter emergency response system of claim 11, wherein the control vest is a colored vest corresponding to a designated color of the day.

13. The active shooter emergency response system of claim 8, wherein the gun vault includes a trauma kit, a control vest, and a long rifle that are accessible after the second lock has been unlocked.

14. The active shooter emergency response system of claim 13, wherein the control vest is a colored vest corresponding to a designated color of the day.

15. An active shooter emergency response system comprising:
a detection system configured to detect a gunshot in a building;
a lighting system having a plurality of lighting elements configured to emit different colors depending up on a proximity to the detected gunshot; and
a plurality of intelligent vaults configured to provide access to weapons and vests for those responding to the detected gunshot.

16. The active shooter emergency response system of claim 15, further comprising a notification system configured to send a push notification to mobiles devices regarding the detection of the gunshot.

17. The active shooter emergency response system of claim 15, wherein the lighting system includes a first plurality of lighting elements configured to emit red light, a second plurality of lighting elements configured to emit orange light, a third plurality of lighting elements configured to emit yellow light, and a fourth plurality of lighting elements configured to emit green light.

18. The active shooter emergency response system of claim 17, wherein the plurality of first lighting elements are configured to enter into a fast strobe state to indicate imminent danger based on presence of the active shooter.

19. The active shooter emergency response system of claim 15, wherein the plurality of intelligent vaults includes a vault having a gun, a vest, and a trauma kit.

20. The active shooter emergency response system of claim 15, wherein the plurality of intelligent vaults includes a vault having an identity verification system.
